(19) United States
(12) Patent Application Publication
(10) Pub. No.: US 2005/0196699 A1
(43) Pub. Date: Sep. 8, 2005

(54) Polymers and photoresists comprising same

(75) Inventors: Subbareddy Kanagasabapathy, Worcester, MA (US); George G. Barclay, Jefferson, MA (US)

Correspondence Address: Peter F. Corless;Edwards & Angell, LLP, P.O. Box 55874, Boston, MA, 02205, US

(73) Assignee: Rohm and Haas Electronic Materials LLC, Marlborough, MA (US)

(21) Appl. No.: 11/072,610

(22) Filed: Mar. 3, 2005

Related U.S. Application Data
(60) Provisional application No. 60/550,016, filed on Mar. 3, 2004.

(51) Int. Cl. G03C 1/76

(52) U.S. Cl. 430/270.1

(57) ABSTRACT

New polymers are provided that contain both Ti and Si atoms and photoimageable compositions that contain such polymers. Preferred polymers are organic, e.g. one or more polymer repeat units comprise carbon atom(s). Polymers of the invention are particularly useful as a resin component of photoresists imaged at short wavelengths such as sub-300 nm and sub-200 nm.

### BACKGROUND

1. Field of the Invention

The present invention relates to new polymers that comprise both Si and Ti atoms and photoimageable compositions that contain such polymers. Preferred polymers are organic, e.g. one or more polymer repeat units comprise carbon atom(s). Particularly preferred are polymers that comprise SiO₂ and/or TiO₂ repeat units and which can be highly useful as a resin component of photoresists imaged at short wavelengths such as sub-300 nm and sub-200 nm.

2. Background

Photoresists are photosensitive films used for transfer of images to a substrate. A coating layer of a photoresist is formed on a substrate and the photoresist layer is then exposed through a photomask to a source of activating radiation. The photomask has areas that are opaque to activating radiation and other areas that are transparent to activating radiation. Exposure to activating radiation provides a photoinduced chemical transformation of the photoresist coating to thereby transfer the pattern of the photomask to the photoresist-coated substrate. Following exposure, the photoresist is developed to provide a relief image that permits selective processing of a substrate.

Photoresists are of particular interest that can be photoimaged with short wavelength radiation, including exposure radiation of about 300 nm or less, or 200 nm or less, such as wavelengths of about 248 nm (provided by KrF laser), 193 nm (provided by an ArF exposure tool), or 157 nm (provided by a F₂ excimer tool). See European Published Application EP915382A2.

Use of such short exposure wavelengths can enable formation of smaller features. Accordingly, a photoresist that yields well-resolved images upon 248 nm, 193 nm or 157 nm exposure could enable formation of extremely small (e.g. sub-0.2 or 0.1 μm) features that respond to constant industry demands for smaller dimension circuit patterns, e.g. to provide greater circuit density and enhanced device performance.

In addition to using shorter wavelengths during exposure, it is also desirable to use a thinner layer of resist. However, the major drawback of using a thin layer of resist is that the variation of resist thickness over a diffusion step on a substrate and into an etched pattern increases as the pattern size becomes smaller. This variation means that the dimensions of any pattern being imaged in the resist will vary as the step geometry is traversed. Therefore, in a single layer resist system, the lack of dimensional control on the wafer can create different line widths throughout the resist which reduces the quality of the electronic package.

To attempt to improve dimensional control, bilayer (or bilevel or multilevel) resist systems have been utilized. In a typical bilevel system, a bottom resist is first applied to a substrate to planarize wafer topography. The bottom resist is cured and a second thinner imaging top resist is then applied over the bottom resist. The top resist is then soft baked, and patterned (or imaged) using conventional resist exposure and development, followed by etch transfer of the top pattern through the bottom resist using the top resist pattern as an etch mask. See Sugiyama et al., Positive Excimer Laser Resists Prepared with Aliphatic Diazoketones, Soc. Plastics Eng., Conference Proceedings, pages 51-60 (November 1988); and U.S. Pat. Nos. 4,745,169; 5,338,818; 5,619,396; 5,731,126; 6,296,985; and 6,340,734. See also WO 02/091083; U.S. Patent Publication 2002/0090572; and U.S. Pat. No. 5,378,585.

Certain inorganic Si compositions for imaging have been reported. See Fedynyshyn et al., Encapsulated Inorganic Resist Technology, Proceedings of SPIE, vol 3999, p. 627 (2000); Y. Hu et al., Nanocomposite resists for electron beam lithography, Microelectronic Engineering 56, 289 (2001); L. Merhai et al., Nanocomposite resists systems for next generation lithography, Microelectronic Engineering 1 (2002). These reported systems are currently not practical for high performance applications.

A problem associated with the thin-layer bi-layer resist systems is to provide acceptable transparency to exposure radiation as well as good resistance to plasma etchants. This is particularly an issue for bi-layer resists that are imaged at sub-200 nm wavelengths such as 193 nm and 157 nm. See US Published Application 2003/0207205 and U.S. Pat. No. 6,593,058, where efforts at increasing etch resistance of bi-layer resists are reported.

It would be desirable to have new photoresists that could provide small images of high resolution. It would be particularly desirable to have new photoresists that could be effectively imaged with short wavelength radiation, including sub-300 nm such as 248 nm and sub-200 nm radiation such as 193 nm and 157 nm. It would be further desirable to have such photoresists that exhibited plasma etch resistance and good transparency to short exposure wavelengths such as 193 nm and 157 nm.

### SUMMARY OF THE INVENTION

We now provide new relates to polymers that have both Si and Ti atoms and photoresists that comprise such polymers. Preferred polymers of the invention have organic content, particularly one or more carbon-containing moieties that may be pendant or integral to the polymer backbone.

Preferred polymers of the invention include functional groups that can enable photoimaging, e.g. a photoacid-labile groups such as photoacid-labile ester or acetal groups or other contrast-enhancing groups such as a fluorinated alcohol (to provide positive-tone resist relief images), or sites for crosslinking such as hydroxy (to provide a negative-tone resist relief image).

Preferred polymers of the invention have a high SiO and/or TiO content, particularly where the polymer comprises repeat units that in combination have an SiO formula of SiO_{1.5<x<2} or a TiO formula of TiO_{1.5<x<2}.

As discussed above, preferred polymers are organic and comprise one or more repeat units that comprise carbon-containing groups such as alkyl, carbon alicyclic, or carbocyclic aryl such as phenyl, naphthyl and the like. Preferably, the carbon-containing groups aere interspersed throughout a polymer (e.g. not just end groups) and may be pendant groups or comprise part of the polymer backbone. Suitably, at least 5 weight percent of a polymer is carbon, and preferably at least about 10, 20, 30 or 40 weight percent of a polymer is carbon.

Particularly preferred polymers of the invention for use in photoimageable compositions of the invention include copolymers that comprise the silicate formula SiO₂ or TiO₂ as one of the multiple, distinct copolymer repeat units. For example, such preferred polymers may have an SiO formula of SiO_{1.5<x<2} and contain photoacid-labile groups, e.g. photoacid-labile ester or acetal groups as a component of one or more repeat units, or other contrast-enhancing group such as a fluorinated alcohol as a component of one or more repeat units.

Particularly preferred polymers of the invention include polymers that have 2 or more distinct repeat units (e.g. terpolymers, tetrapolymers), which may include additional repeat units to provide for further modulation of photoresist properties.

Preferred polymers of the invention include those where Si and Ti atoms are present on distinct polymer repeat units, e.g. where a first repeat unit comprises one or more Si atoms, but no Ti atoms, and a second repeat unit distinct from the first repeat unit comprises one or more Ti atoms, but no Si atoms. More particularly, preferred are polymers that comprise a structure of the following formula (1):
-(A)ₓ-(B)_{y}-(C)_{z}- (I)

where A is a repeat unit that comprises one or more Si atoms but no Ti atoms;

B is a repeat unit that comprises one or more Ti atoms but no Si atoms; and

C is an optional repeat unit that comprises one or more carbon atoms, but no Ti atoms;

x and y are mole percent of the respective repeat units based on total polymer units and are each greater than zero; and z is the mole percent of the respective repeat unit (unit C) based on total polymer units and may be zero (where C units are not present) or greater (where C units are present). Preferred C units may comprise e.g. one or more optionally substituted alkyl groups or one or more optionally substituted carbocyclic aryl groups.

In another aspect, preferred polymers of the invention may be characterized as being obtainable by reaction of one or more compounds that comprise Si and/or Ti atoms with at least two reactive groups (e.g. leaving groups) for a hydrolysis or condensation reaction, more preferably three or four such reactive groups. Preferred reactive groups (e.g. leaving groups) include halogen (particularly Cl, Br and I), alkoxy, aryloxy, or a group such as hydroxy that can be modified to a suitable leaving group. Mixtures of reactive groups also are suitable. For example, a monomer containing both halogen and alkoxy groups may be advantageously used.

In such aspects of the invention, preferred polymers of the invention may be provided by reaction of one or more compounds of the following formula (II):
M(Y)₄ (II)

wherein each M is independently Si or Ti;

each Y is the same or different and at least two Y groups are reactive groups (e.g. leaving groups) toward a hydrolysis or condensation reaction, preferably three or four Y groups are such reactive groups.

Preferred polymers of the invention will have a high content of Si and Ti atoms, e.g. at least about 10, 12, 15, 16, 17, 18, 19 or 20 atom weight percent of total polymer being Si and Ti.

Preferred polymers also may be fluorinated, e.g. comprise carbons having one or more fluorine atoms as part of the polymer pendant groups. For instance, preferred polymer substituents include —CF₃ and other C₁₋₂₀haloalkyl groups particularly C₁₋₂₀fluoroalkyl groups such as —CHF₂, —CH₂F, —CH₂CF₃, —CF₂CF₃, and the like as well as haloalkoxy particularly fluoroalkoxy such as C₁₋₂₀fluoroalkoxy, e.g. —OCF₃, —OCH₂CF₃, and the like. Such fluorine substituents may be directly linked to an Si atom of a polymer, or may a substituent of another polymer group such as an alicyclic unit. Also suitable is direct fluorine substitution of Si atoms, e.g. groups of the formula Si—F, Si—F₂, and the like.

Also preferred for many applications are polymers of the invention that comprise repeat units with alcohol moieties.

For short-wavelength imaging, particularly sub-nm 200 imaging, preferably the polymer has low aromatic content to provide enhanced transparency. For instance, preferred polymers for such short wavelength imaging will be substantially free of aromatic groups, e.g. less than about 5, 4, 3, 2, 1 or 0.5 mole percent aromatic groups based on total polymer units. Even more preferred will be polymers that are completely free of aromatic groups.

Preferred polymer pendant units for use in resists imaged at 193 nm include alicyclic groups that can modulate resistance to plasma etchants. Optionally substituted norbomyl, adamantyl, fencyl and isobomyl are preferred alicyclic groups, although other alicyclic moieties having 1 to 4 separate or fused alicyclic rings and from 5 to about 20 ring atoms also will be suitable. Preferably, such alicyclic groups will contain photoacid-labile or other contrast-enhancing moieties such as a photoacid-labile ester or acetal group or a fluorinated alcohol.

Polymers of the invention also suitably may contain phenolic or other aromatic groups, particularly where the polymer is used in a resist imaged at higher wavelengths, particularly wavelengths greater than 200 nm such as such as 248 nm. Polymers having phenolic or other aromatic substitution also may be useful in photoresists imaged with E-beam or EUV radiation sources. Such polymers that contain aromatic groups may be provided e.g. by polymerization of a phenyl group substituted with a trichlorosilyl group, trialkoxysilyl, and the like.

Polymers of the invention suitably may have a variety of molecular weight polydispersity values (i.e. Mw/Mn). For instance, suitable polymers include those that have an Mw/Mn of about 20 or less, more typically about 10 or less, or about 5 or 4 or less. For many applications, narrow molecular weight polydispersities may be preferred, such as an Mw/Mn of about 3 or 2 or less, or even lower such as about 1.7, 1.6, 1.5, 1.4, 1.3 or 1.2 or less.

In another aspect, the present polymers may be polymerized in the form discrete particles, i.e. as separate and distinct polymer particles. Such polymer particles typically have one or more different characteristics from linear or ladder silicon polymers. For example, such polymer particles typically have a defined size and a low molecular weight distribution.

More particularly, in a preferred aspect, a plurality of the polymer particles of the invention typically has a mean particle size of from about 5 to 3000 angstroms, more preferably from about 10 to 2000 angstroms, still more preferably from about 10 to about 1000 angstroms, yet more preferably from about 10 to about 500 angstroms, even more preferably from 10 to 50 or 100 angstroms.

A plurality of preferred polymer particles of the invention typically has a narrow molecular weight polydispersity (Mw/Mn), such as about 1.3, 1.2 or 1.1 or less and even approaching about 1 as may be determined by gel permeation chromatography and/or mass spectroscopy.

In a further aspect, photoresists and polymers are provided that are highly transparent to 157 nm radiation. In particular, the invention provides photoresists suitable for 157 nm imaging that comprise a photoactive component and a polymer component, where the resist composition has a low absorbance of 157 nm radiation such as an absorbance of 1.5 or less (i.e. Abs₁₅₇/μM of 1.5 or less). Even lower absorbing photoresists are provided, including photoresists suitable for 157 nm imaging that comprise a photoactive component and a polymer component, where the photoresist composition has an Abs₁₅₇/μM of 1.4, 1.3 or 1.2 or less, or an Abs₁₅₇/μm of 1.1 or 1 or less, or even an Abs₁₅₇/μm of 0.9, 0.8 or 0.7 or less or an Abs₁₅₇/μm of 0.6 or 0.5 or less.

In such photoresists, the photoactive and polymer components may be a single integral material (e.g. a resin with covalently linked photoacid generators), but more typically those components will be distinct (not covalently linked) materials e.g. a resist that contains one or more photoacid generator compounds and one or more distinct polymers.

In addition to such resists, photoimageable polymers are provided that exhibit low absorbance of 157 nm radiation. In this aspect, preferred photoimageable polymers will have an Abs₁₅₇/μm of 1.2 or 1.1 or less, or an Abs₁₅₇/μm of 1 or less, or even an Abs₁₅₇/μm of 0.9, 0.8, 0.7, 0.6 or 0.5 or less. Preferred are the Si copolymers, particularly the present Si polymers that have an SiO formula of SiO_{1.5<x<2}. Fluorinated polymers are especially preferred.

Absorbance values (including Abs₁₅₇/μm values) as referred to herein are determined by the following protocol. A photoresist or polymer film is spin coated on a silicon microelectronic wafer substrate and solvent is removed by a soft-bake (110° C. for 60 seconds) with a vacuum hotplate. The absorbance of the dried coating layer is measured at the specified radiation wavelength (e.g. 157 nm) using a VU-301 vacuum ultraviolet variable angle spectroscopic ellipsometer (VUV-VESA) instrument (suitably as commercially available from J. A. Woollam Co.). The measured absorbance is normalized to 1 μm photoresist or polymer film coating thickness.

In addition to a resin of the invention, typical photoresist compositions of the invention also will contain a photoactive component, e.g. one or more photoacid generator compounds. References herein to a polymer or a resin of the invention are inclusive of that polymer in particle form.

Photoresists also will include a mechanism to provide sufficient solubility differentials between exposed and unexposed regions of a coating layer of the resist to enable formation of a relief image upon development.

Chemically-amplified positive-acting photoresists suitably will contain a component that preferably has one or more photoacid-labile deblocking groups, i.e. groups that undergo reaction in the presence of photogenerated acid to provide a polar group such as carboxy, hydroxy and the like. Preferred photoacid-labile groups include photoacid-labile esters or acetal groups. Such photoacid-labile group(s) suitably will be substituents of the silicon-containing resin, but the resist also may contain a separate component such as a separate oligomer or polymer that contains such photoacid-labile group(s).

Positive photoresists imaged at short wavelengths also may suitably contain fluorinated alcohol groups, e.g. alcohols that have proximate (within one, two or three carbons from the hydroxy-substituted carbon) fluorine substitution.

Negative-acting resists of the invention typically will contain an agent for crosslinking of one or more of the components of the resist, typically a separate crosslinker component such as an amine-based reagent, e.g. a melamine or benzoguanamine resin. Resins used in negative-acting photoresists preferably contain primary or secondary alcohol moieties.

Photoresists of the invention are preferably employed in multilayer lithography systems. More particularly, preferred uses of resists of the invention include application of a first organic polymer coating on a substrate, e.g. a semiconductor microelectronic wafer, and applying thereover a photoresist of the invention. The organic bottom layer suitably may be non-photoimageable (e.g. not contain a photoacid generator compound) but is thermally crosslinked prior to application of the resist layer. The bottom layer may comprise a phenolic polymer such as a novolac admixed with a thermal acid generator compound and a crosslinker. Use of such a bottom layer can enable application of a very thin top resist layer.

The invention also provides methods for forming relief images, including methods for forming a highly resolved relief image such as a pattern of lines where each line has essentially vertical sidewalls and a line width of about 0.40 microns or less, and even a width of about 0.2, or 0.10 microns or less, such as lines having widths of 80 nm or less. The invention further provides articles of manufacture comprising substrates such as a microelectronic wafer substrate (e.g. a wafer having a diameter of less than 20 or 10 inches), optoelectronic device substrate, waveguide or liquid crystal display substrate or other flat panel display substrate having coated thereon a polymer, photoresist or resist relief image of the invention. The invention also includes methods to produce such articles of manufacture, which comprise use of a photoresist of the invention.

### DETAILED DESCRIPTION OF THE INVENTION

As discussed above, we now provide polymers that have both Si and Ti atoms.

In one particular aspect, photoimageable copolymers that contain Si and Ti atoms are provided and that comprise repeat units of SiO₂ and/or TiO₂.

In another aspect, photoimageable copolymers are provided that comprise Ti and Si atoms and repeat units that in combination have an SiO formula of SiO_{1.5<x<2} (e.g. at least a portion such as at least 10, 20, 30, 40, 50, 60, 70, 80 or 90 percent of total repeat units of the polymer has such a SiO formula) and/or where the entire photoimageable copolymer has an SiO formula of SiO_{1.5<x<2}.

In yet another aspect, photoimageable copolymers are provided that comprise Ti and Si atoms and repeat units that in combination have a TiO formula of TiO_{1.5<x<2} (e.g. at least a portion such as at least 10, 20, 30, 40, 50, 60, 70, 80 or 90 percent of total repeat units of the polymer has such a TiO formula) and/or where the entire photoirnageable copolymer has an TiO formula of TiO_{1.5<x<2}.

References herein that a polymer (including copolymer) is photoimageable indicate that the polymer has one or more photoacid-labile moieties such as a photoacid-labile ester (e.g. t-butylester) or acetal group, or other contrast-enhancing group such as a fluorinated alcohol. In other words, for example, as a component of a photoresist composition, the photoimageable polymer can react (e.g. a cleavage reaction) or otherwise operate together with photogenerated acid (such as produced from a photoacid generator compound) to provide developer solubility differentials between exposed and unexposed regions of a coating layer of the photoresist.

As discussed above, contrast-enhancing groups also may include sites for crosslinking, in the case of a polymer used in a negative resist.

Preferred polymers of the invention include polysiloxanes that contain Ti substitution. Also preferred polymers of the invention are polysilsesquioxanes that contain Ti-substitution as well as polymers that contain polysilsesquioxane regions or repeat units. As is recognized, the term silsesquioxane refers to silicon structures of the formula RSiO_{3/2} where R is a hydrogen or carbon-containing moiety such as optionally substituted alkyl, optionally substituted aryl and the like.

Preferred polymers of the invention may comprise a structure of the following formula (III):

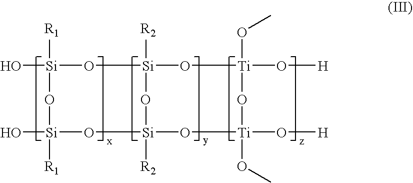

wherein in that formula each R₁ and each R₂ independently may be hydrogen; optionally substituted alkyl preferably having from 1 to about 20 carbon atoms; optionally substituted carbon alicyclic; optionally substituted aryl and preferably optionally substituted carobyclic aryl such as optionally substituted phenyl, optionally substituted naphthyl and the like; where preferably at least one R₁ and/or R₂ are other than hydrogen, i.e. at least one R₁ and/or R₂ is a carbon-containing group; and

preferably at least one R₁ and/or R₂ comprises a photoacid-labile group such as a photoacid-labile ester or acetal group, or at least one of R₁ and R₂ comprises another contrast-ehancing group such as a fluorinated alcohol (e.g. —CH(CF₃)₂OH and the like);

x, y and z are each mole percents of the respective polymer units based on total polymer units are each greater than zero, and preferably x, y and z are each at least 5 or 10 mole percent based on total polymer units.

Polymers of the invention can be readily synthesized. Preferred syntheses include a condensation or hydrolysis reaction under acidic or basic conditions. If any of the reactants are acid-sensitive, such as a photoacid-labile moiety, then preferably the polymerization reaction is conducted under basic conditions. See generally the syntheses reported in Organometallic Chemistry, 15: 1610 (1996) and Tetrahedron Letters, 58: 239 (2002).

In general, one or more reactive Si and Ti reactants such as those of the above Formula II above are reacted in the presence of base and water with one or more other reactants preferably in a suitable organic solvent for a time sufficient to form the desired polymer. The reaction can be run at elevated temperatures as needed to promote polymerization e.g. at 50° C., 70° C., 80° C. or 90° C. or higher. Preferably, one or more organic solvents are used, e.g. an ether, ketone or aromatic solvent such as acetone, propylene glycol methyl ether acetate, glyme, toluene, xylenes and the like. The amount of water is typically present in an amount of a molar equivalent or excess relative to the leaving group(s) on the Si and/or reactant (e.g. a reactant of Formula II above). The base may be an organic or inorganic reagent. Good results have been obtained with organic bases such as triethylamine, dicyclohexylamine and the like. The base is suitably present in a molar equivalent or excess relative to the Si reagent. See Example 6 which follow for exemplary reaction conditions.

In general, a molar excess of water and base and elevated reaction temperatures can be employed to promote or enhance polymerization.

While use of base can be preferred where acid-sensitive groups (such as photoacid-labile moieties) are present, an alternative approach employs an acid-based condensation reaction to form the polymer and then functionalized the formed polymer with photoacid-labile groups, or other acid-sensitive groups as may be desired.

As discussed above, a variety of other monomers or oligomers may be reactant with an Si and/or Ti reagent such as those of the above Formula II. Preferred Si reactants will have a reactive Si group such any or a variety of hydrosilylated or halosilylated monomers. See, for instance, the reactants used in Example which follows.

Preferred polymers of the invention include those that are formed from polymerization of a silyl halide or silyl alkoxide, including trihalo and trialkoxy compounds such as those of the formula R—Si(OC₁₋₃alkxoy)₃ e.g. R—Si(OCH₂CH₃)₃ or R—Si(halide)₃ e.g. R—Si(Cl)₃, as well as mixed alkoxy-halosilanes such as RSi(Cl)₂(OR) and RSi(OR)₂Cl. The R moiety on such compounds suitably may be aromatic (e.g. phenyl or naphthyl) or more preferably non-aromatic such as an optionally substituted alkyl or alicyclic groups such as norbornyl, adamantyl or the like. Such R groups may be substituted by a photoacid-labile group e.g. acid-labile ester such as t-butyl ester or acetal group, or an acetal group, or by aqueous base-solubilizing groups such as a fluorinated alcohol, sulfonamide, thiol, or the like. Such groups may be further substituted with electron-withdrawing groups such as fluorine, cyano, etc.

A preferred co-reactant with such trihalo or trialkoxy or mixed tri(halo/alkoxy) reactants is a tetrafuictional (4 leaving groups) reactant such as a tetraalkoxysilane that can react to provide SiO₂ units in the formed polymer, whereas the such trihalo or trialkoxy or mixed tri(halo/alkoxy) reactants provides Si(R)O_{3/2} polymer units.

Specifically suitable Si reactants include tetraethoxysilane, tetrapropoxysilane, triethoxychlorosilane (SiCl(Et)₃), and hexachlorodislane. Such reagents can be readily prepared or are commercially available from vendors such as Gelest (Tullytown, Pa.).

Specifically suitable Ti reactants include e.g. Ti (IV) chloride, Ti (IV) butoxide, and Ti (IV) ethoxide. Such reagents can be readily prepared or are commercially available from vendors such as Gelest (Tullytown, Pa.).

We also have found the hydrolysis and condensation reactions of tetrafunctional metallic organic reactants such as tetraalkoxysilanes proceed at rates significantly faster than those of large, steric hindered trialkoxy organic silanes such as hexafluoroisopropanolnorbonyl(HFIPNB)-triethoxysilane. Such reactivity differences can result in producing polymers with large molecular weight distributions containing multiple distinct molecular components. Gelation of the reaction mixture also can occur with reaction of large, steric hindered reactants such as large trialkoxy organic silanes.

We have further found that such wide molecular weight distribution and gelation can be avoided if the triethoxysilane co-reactant R group is a relatively small alkyl e.g. of 1 to 12 carbon atoms (with no branches on the α-carbon) and that do not sterically inhibit or slow down the hydrolysis or condensation reactions. Examples of such an R group include fluoroalcohols such as 1,1,1-trifluoro-2-trifluoromethyl-pent-4-en-2-ol (BTHB)-triethoxysilane, 1,1,1-trifluoro-2-trifluoromethyl-pent4-en-2-ol-ethoxy methyl ether-triethoxysilane, (1,1-bis-trifluoromethyl-but-3-enyloxy)-acetic acid tert-butyl ester (BTHBTBAC)-triethoxysilane, triethoxysilane of 3-trifluoromethyl-3-hydroxy-1-propene, and non fluoroalcohols such 2,2,2-trifluoroethyl-triethoxysilane or triethoxysilane of 2,2,2-trifluoroethyl ethylether. Abbreviations for certain substituent groups are used herein, including the following: TFAMNBB designates 2-trifluonnethyl-bicyclo[2.2.1]hept-5-ene-2-carboxylic acid tert-butyl ester; BTHB designates 1,1,1-trifluoro-2-trifluoromethyl-pent-4-en-2-ol; BTHBTBAC designates (1,1-bis-trifluoromethyl-but-3-enyloxy)-acetic acid tert-butyl ester; and EOM designates ethoxyl methyl ether.

We have further found that reactants with such small R groups are favored to produces the discrete polymer particles of the invention. That is, the small R group containing trialkoxysilanes can condense with a tetraalkoxysilane to form dense, highly cross-linked, soluble, film-forming polymer structures (particles) that with appropriate substituents (e.g. photoacid-labile ester or acetal groups) can be photo-imaged as a photoresist composition. The formation of these particles can be catalyzed either by acid or base, preferably under strong base catalysis at elevated temperatures.

As discussed above, as generally referred to herein, a photoimageable polymer will contain one or more repeat units that comprise photoacid-labile groups, such as photoacid-labile ester or acetal groups, or other contrast-enhancing groups such as a fluorinated alcohol, or the polymer will have sites that can crosslink with a crosslinker component (e.g. an amine-based crosslinker such as a melamine).

In copolymers (which includes polymers with at least two distinct repeat units and higher order polymers such as terpolymers and tetrapolymers) of the invention, each distinct repeat unit may be suitably present in a variety of relative amounts. Repeat units that have photoacid-labile groups suitably may be present in a polymer from about 1, 2 or 3 to about 10, 15, 20, 30, 40, 50 or 60 or more percent, based on total repeat units of the polymer, more preferably about 5, 10 or 20 to about 30, 40 or 50 mole percent based on total units of the polymer. Repeat unit(s) that do not contain photoacid labile groups and are not high in Si or Ti content (i.e. either do not contain Si or Ti atoms or do not contain SiO₂ or TiO₂ groups), e.g. units that contain an alicyclic or phenyl group to modulate etch resistance, suitably may be present in a polymer from about 1, 2 or 3 to about 50 or 60 mole percent, based on total repeat units of the polymer, more preferably about 5, 10 or 20 to about 30 or 40 or 50 mole percent based on total units of the polymer.

Preferred Si/Ti-polymers for use in a negative-acting resist composition will comprise suitably primary and secondary hydroxy moieties, suitably primary or second alcohol groups that may be present as hydroxyC₁₋₂₀alkyl groups. Such primary and secondary hydroxy can be effective sites or moieties for crosslinking.

With reference to Formulae I, II and III above, and other polymers groups discussed herein, the term “aryl” without further limitation includes both carbocyclic aryl and heteroaryl groups.

The term “carbocyclic aryl” includes groups that contain 1 to 3 separate or fused rings and from 6 to about 18 ring atoms, without hetero atoms as ring members. Specifically preferred carbocyclic aryl groups include phenyl, and naphthyl including 1-napthyl and 2-naphthyl and acenaphthyl, phenanthrencyl, and the like.

The term “heteroaryl refers to herein heteroaromatic groups that typically contain 1 to 3 seprate or fused ring with 1 or more, typically 1 to 3 N, O or S ring atoms and from 5 to 20 total ring atoms. Exemplary heteroaryl groups include, e.g., quinolinyl, pyridyl, pyrazinyl, indolyl, carbazoyl, furyl, pyrrolyl, thienyl, thiazolyl, pyrazolyl, oxazolyl, imidazolyl, indolyl, benzofuranyl, benzothiazolyl, pyridonal, and the like.

The term “alkyl” is intended to include both branched and straight-chain saturated aliphatic hydrocarbon groups, having the specified number of carbon atoms. Examples of alkyl include methyl, ethyl, n-propyl, i-propyl, n-butyl, s-butyl, t-butyl, n-pentyl, and s-pentyl. Preferred alkyl groups are C₁-C₁₂ alkyl groups. An alkyl group includes cyclic structures and may contain a multiple carbon-carbon bond provide the group is not aromatic (i.e. the term alkyl includes alicyclic, alkenyl and alkynyl).

As referred to herein, the term “carbon alicyclic” means each ring member of the non-aromatic group is carbon. The carbon alicyclic group can have one or more endocyclic carbon-carbon double bonds, provided the ring is not aromatic. Exemplary carbon alicyclic groups include cyclohexyl, norbomyl, adamantly, fenchyl, and the like. Typically carbon alicyclic groups may have from 3 to 18 or more ring atoms and 1 to 3 or 4 fused or otherwise linked rings.

“Haloalkyl” is intended to include both branched and straight-chain alkyl (as specified above), substituted with 1 or more halogen atoms. Preferred examples of haloalkyl include, but are not limited to, mono-, di-, or tri-fluoromethyl, mono-, di-, or tri-chloromethyl, mono-, di-, tri-, tetra-, or penta-fluoroethyl, and mono-, di-, tri-, tetra-, or penta-chloroethyl. Typical haloalkyl groups will have 1 to about 12 carbon atoms, more typically 1 to about 6 carbon atoms.

“Alkoxy” represents an alkyl group as defined above inclusive of an oxygen bridge. Examples of alkoxy include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, and 3-methylpentoxy. Alkoxy groups typically have 1 to about 12 carbon atoms, more typically 1 to about 6 carbon atoms.

“Halolkoxy” includes a haloalkyl group as defined above with a further oxygen bridge. Preferred examples of haloalkoxy groups include trifluoromethoxy, 2-fluoroethoxy, and difluromethoxy.

The term “aryloxy” refers to an aryl that is an alkoxy group that has an aryl substituent, or an aryl group that has oxygen ring substitution and that oxygen is linked to a further group, for instance phenoxy is a preferred aryloxy group. Carbocyclic aryloxy groups are preferred for certain applications.

As used herein, the terms “alkylsulfonyl” or “alkylsulfonate” includes those groups having one or more sulfonyl (SO₂) or sulfonate (SO₃) respectively and typically from 1 to about 12 carbon atoms, more typically 1 to about 6 carbon atoms.

As discussed, various polymer moieties may be optionally substituted, including groups of Formulae I, II and III. A “substituted” substituent may be substituted at one or more available positions, typically 1, 2, or 3 positions by one or more suitable groups such as e.g. halogen (particularly F, Cl or Br); cyano; C₁₋₈ alkyl; C₁₋₈ alkoxy; C₁₋₈ alkylthio; C₁₋₈ alkylsulfonyl; C₂₋₈ alkenyl; C₂₋₈ alkynyl; hydroxyl; alkanoyl such as a C₁₋₆ alkanoyl e.g. acyl and the like; etc. For polymers used in resists imaged at 157 nm, substitution by fluorine and other electronegative groups will be preferred, while substitution by carbonyl groups will be less desirable due to excessive absorbance of 157 nm radiation by that functionality.

Preferred photoimageable polymers of the invention that contain SiO₂ groups are distinct from silicate (SiO₂) polymers, including SiO₂ homopolymers and surface-treated SiO₂ polymers.

For instance, preferred photoimageable SiO₂ copolymers of the invention do not require surface treatment to provide a non-SiO₂ component or a photoimageable functionality (such as a photoacid-cleavable ester or acetal group or a fluorinated alcohol). Additionally, preferred SiO₂ copolymers of the invention do not contain extended polymer regions that consist only of SiO₂ repeat units, e.g. preferred copolymers of the invention would not typically contain a region that had 200, 150, 100, 80, 50, 40 or even 20 SiO₂ units in uninterrupted sequence. Rather, in a preferred polymer of the invention, SiO₂ units would be dispersed in the polymer with other polymer units, such as repeat units of the formula RSiO_{3/2} with that R group being e.g. hydrogen or more preferably a carbon-containing group such as C₁₋₁₂alkyl, carbon alicyclic or carbocyclic aryl.

As discussed, photoimageable compositions of the invention are preferably used in multiple-layer systems, i.e. where the photoimageable composition is disposed over a further organic (polymer composition) layer that itself is disposed over a substrate surface such as a microelectronic wafer or device substrate or an optical waveguide substrate.

Suitable underlayer compositions include those that comprise a phenolic polymer such as a novolak and/or poly(vinylphenol). Also preferred is where the underlying polymer composition is a crosslinking composition, e.g. contain an acid or acid generator compound such as a thermal acid generator compound and preferably a separate crosslinker component such as an amine-based material, e.g. a melamine or benzoguanamine resin. For such crosslinking composition, the applied underlayer may be crosslinked prior to application of the overcoated photoimageable composition, e.g. by suitable thermal treatment such as heating at 140° C., 150° C., 160° C., 180° C., 200° C. or 230° C. for a time sufficient for crosslinking such as 0.5, 1 or 2 minutes. In many aspects, the underlying polymer composition is suitably non-photoimageable. Preferably, the anti-reflective characteristics (absorbance) of the underlayer is matched to the top resist layer so that radiation reflected from the substrate can pass back to the resist layer in an amount sufficient to enhance the lithographic process.

Suitably, more than one Ti/Si-containing polymer may be used in the present photoimageable compositions. Thus, the present photoimageable compositions may include one, two or more Ti/Si-containing polymers. In this way, blends of polymers may be advantageously used in the present photoimageable compositions. Such blends include blends of the present silicon-containing polymers with non-silicon-containing polymers. In these blends, a wide range of ratios of the blended polymers may be suitable. The specific ratio will depend upon the particular polymers combined and the characteristics (dissolution rate, etch resistance, photospeed, etc.) desired.

A wide variety of photoactive components may be used in the present invention, including, but not limited to, photoacid generators and photobase generators. Photoacid generators are preferred. It will be appreciated by those skilled in that art that more than one photoactive component may be used advantageously in the photoimageable compositions of the present invention.

The photoacid generators useful in the present invention are any compounds which liberate acid upon exposure to activating radiation, e.g. sub-300 nm radiation such as 248 nm, or sub-200 nm radiation such as 193 nm or 157 nm. Suitable photoacid generators include e.g. imidosulfonaytes, onium salts, halogenated triazines, sulfonated esters and halogenated sulfonyloxy dicarboximides.

Preferred PAGs for imaging at 157 nm, 193 nm and 248 nm imaging include imidosulfonates such as compounds of the following formula: 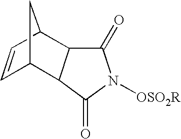
wherein R is camphor, adamantane, alkyl (e.g. C₁₋₁₂ alkyl) and perfluoroalkyl such as perfluoro(C₁₋₁₂alkyl), particularly perfluorooctanesulfonate, perfluorononanesulfonate and the like. A specifically preferred PAG is N-[(perfluorooctanesulfonyl)oxy]-5-norbornene-2,3-dicarboximide.

Sulfonium and iodonium salts also suitable PAGS, particularly sulfonate salts. Two suitable agents for 193 nm and 248 nm imaging are the following PAGS 1 and 2:

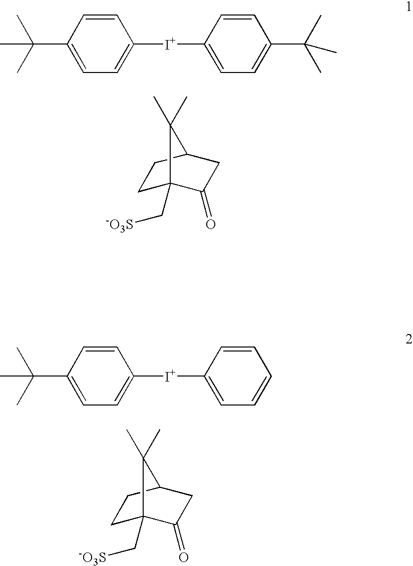

Such sulfonate compounds can be prepared as disclosed in European Patent Application 96118111.2 (publication number 0783136), which details the synthesis of above PAG 1.

Also suitable are the above two iodonium compounds complexed with anions other than the above-depicted camphorsulfonate groups. In particular, preferred anions include those of the formula RSO₃- where R is adamantane, alkyl (e.g. C₁₋₁₂ alkyl) and perfluoroalkyl such as perfluoro (C₁₋₁₂alkyl), particularly perfluorooctanesulfonate, perfluorobutanesulfonate and the like.

For imaging at 157 nm, a triphenyl sulfonium PAG is particularly preferred, complexed with anions such as the sulfonate anions mentioned above, particularly a perfluoroalkane sulfonate such as perfluorobutane sulfonate.

Particularly useful halogenated triazines include halomethyl-s-triazines. Suitable halogenated triazines include for example, 2-(1-(3,4-benzodioxolyl))-4,6-bis(trichloromethyl)-1,2,5-triazine, 2-(1-(2,3-benzodioxolyl))-4,6-bis(trichloromethyl)-1,3,5-triazine, 2-(1-(3,4-benzodioxolyl))-4,6-bis(tribromomethyl)-1,3,5-triazine, 2-(1-(2,3-benzodioxolyl))-4,6-bis(tribromomethyl)-1,3,5-triazine, and 2-(2-furfylethylidene)-4,6-bis(trichloromethyl)-1,3,5-triazine. Other triazine type photoacid generators useful in the present invention are disclosed in U.S. Pat. No. 5,366,846, herein incorporated by reference.

Halogenated sulfonyloxy dicarboximides also will be useful as photoacid generators such as:
1-(((trifluoromethyl)sulfonyl)oxy)-1H-pyrrole-2,5-dione; N-((perfluorooctanesulfonyl)oxy)-5-norbomene-2,3-dicarboximide; N-((trifluoromethylsulfonyl)oxy)-5-norbomene-2,3-dicarboximide; 1-(((trifluoromethyl)sulfonyl)oxy)-2,5-pyrrolidinedione; 3a,4,7,7a-tetrahydro-2-(((trifluoromethyl)sulfonyl)oxy)-4,7-methano-1H-isoindole-1,3(2H)-dione; 2-(((trifluoromethyl)sulfonyl)oxy)-1H-benz(f)isoindole-1,3(2H)-dione; 3,4-dimethyl-1-(((trifluoromethyl)sulfonyl)oxy)-1H-pyrrole-2,5-dione; 2-(((trifluoromethyl)sulfonyl)oxy)-1H-isoindole-1,3(2H)-dione; and 2-(((trifluoromethyl)sulfonyl)oxy)-1H-benz(de)isoquinoline- 1,3(2H)-dione.

In positive-acting systems of the present invention, the photoactive components are typically added to photoimageable compositions in an amount sufficient to generate a latent image in a coating layer of resist material upon exposure to activating radiation. When the photoactive component is a photoacid generator, the amount is typically in the range of 0.1 to 15 percent by weight, based on the weight of the resin, and preferably 1 to 8 percent by weight.

In negative-acting systems of the present invention, the amount of photoactive component useful is any amount sufficient to catalyze cross-linking of the silicon-containing polymer or oligomer. The photoactive components are typically used in the range of 0.1 to 25% by weight, based on the total weight of the composition dry components (i.e. all components except solvent carrier). It is preferred that the photoactive component is present in an amount in the range of 0.1 to 15% by weight, more preferably in the range of 0.1 to 12% by weight, and still more preferably less than or equal to 5% by weight. A particularly suitable range is from 0.1 to 5% by weight based on total weight of the composition dry components.

Negative-acting resists preferably include one or more cross-linking agents in addition to the resin that both Ti and Si atoms. Any aromatic or aliphatic cross-linking agent that reacts with the silicon-containing polymer or oligomer is suitable for use in the present invention. Such organic cross-linking agents will cure to form a polymerized network with the silicon-containing polymer or oligomer, and reduce solubility in selected solvents. Such organic cross-linking agents may be monomers or polymers. It will be appreciated by those skilled in the art that combinations of cross-linking agents may be used successfully in the present invention.

Suitable organic cross-linking agents useful in the present invention include, but are not limited to: amine containing compounds, epoxy containing materials, compounds containing at least two vinyl ether groups, allyl substituted aromatic compounds, and combinations thereof. Preferred cross-linking agents include amine containing compounds and epoxy containing materials.

The amine containing compounds useful as cross-linking agents in the present invention include, but are not limited to: a melamine monomers, melamine polymers, alkylolmethyl melamines, benzoguanamine resins, benzoguanamine-formaldehyde resins, urea-formaldehyde resins, glycoluril-formaldehyde resins, and combinations thereof. These resins may be prepared by the reaction of acrylamide or methacrylamide copolymers with formaldehyde in an alcohol-containing solution, or alternatively by the copolymerization of N-alkoxymethylacrylamide or methacrylamide with other suitable monomers. Particularly suitable amine-based crosslinkers include the melamines manufactured by Cytec of West Paterson, N.J., such as CYMEL™ 300, 301, 303, 350, 370,380, 1116 and 1130; benzoguanamine resins such as CYMEL™ 1123 and 1125; the glycoluril resins CYMEL™ 1170,1171 and 1172; and the urea-based resins BEETLE™ 60, 65 and 80, also available from Cytec, West Paterson, N.J. A large number of similar amine-based compounds are commercially available from various suppliers.

Melamines are the preferred amine-based cross-linkers. Particularly preferred are alkylolmethyl melamine resins. These resins are typically ethers such as trialkylolmethyl melamine and hexaalkylolmethyl melamine. The alkyl group may have from 1 to 8 or more carbon atoms but is preferably methyl. Depending upon the reaction conditions and the concentration of formaldehyde, the methyl ethers may react with each other to form more complex units.

Particularly suitable amine-based cross-linking agents include those of the following formula:

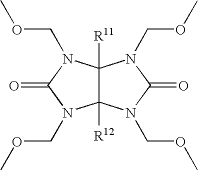

wherein R¹¹ and R¹² are independently selected from H, (C₁-C₆)alkyl and phenyl. Preferred alkyl groups for R¹¹ and R¹² are methyl and propyl.

Epoxy containing materials also may be useful as cross-linkers for negative resists of the invention may be suitably any organic compounds having one or more oxirane rings that are polymerizable by ring opening. Such materials, broadly called epoxides, include, but are not limited to: monomeric epoxy compounds, and polymeric epoxides that may be aliphatic, cycloaliphatic, aromatic or heterocyclic. Preferred epoxy cross-linking materials generally, on average, have at least 2 polymerizable epoxy groups per molecule. The polymeric epoxides include linear polymers having terminal epoxy groups (e.g., diglycidyl ether of a polyoxyalkylene glycol), polymers having skeletal oxirane units (e.g., polybutadiene polyepoxide), and polymers having pendant epoxy groups (e.g., glycidyl methacrylate polymer of copolymer). The epoxides may be pure compounds but are generally mixtures containing one, two or more epoxy groups per molecule. Additionally useful epoxy containing materials for use as crosslinkers include glycidyl ethers. Examples are the glycidyl ethers of polyhydric phenols obtained by reacting a polyhydric phenol with an excess of chlorohydrin such as epichlorohydrin (e.g., the diglycidyl ether of 2,2-bis-(2,3-epoxypropoxyphenol)propane). Such glycidyl ethers include bisphenol A epoxides, such as bisphenol A ethoxylated diepoxide. Further examples of epoxides of this type are described in U.S. Pat. No. 3,018,262.

Photoresists of the invention may optionally further include one or more additional components, including, but not limited to, solvents, anti-striation agents, plasticizers, surfactants, base additives, speed enhancers, fillers, dyes and the like. In positive-acting systems, a base additive is typically used to adjust the photospeed of the composition. Such optional additives will be present in relatively minor concentrations in a photoresist composition except for fillers and dyes which may be used in relatively large concentrations, e.g. in amounts of from about 5 to 30 percent by weight, based on the total weight of the composition's dry components.

Photoresists of the present invention may be readily prepared by those skilled in the art. For example, a photoresist composition of the invention can be prepared by dissolving the components of the photoresist, i.e. polymer binder and photoactive component, in a suitable solvent. Such suitable solvents include, but are not limited to: ethyl lactate, ethylene glycol monomethyl ether, ethylene glycol monomethyl ether acetate, propylene glycol monomethyl ether, propylene glycol monomethyl ether acetate, 3-ethoxyethyl propionate, 2-heptanone, y-butyrolactone, and mixtures thereof. 2-heptanone is often preferred for resists containing a fluorinated polymer.

Typically, the solids content of the photoresist composition varies from about 5 to about 35 percent by weight, based on the total weight of the composition. The resin binder and photoactive components should be present in amounts sufficient to provide a film coating layer and formation of good quality latent and relief images.

Such photoresist compositions may be applied to a substrate by any known means, such as spinning, dipping, roller coating and the like. When the compositions are applied by spin coating, the solids content of the coating solution can be adjusted to provide a desired film thickness based upon the specific spinning equipment utilized, the viscosity of the solution, the speed of the spinner and the amount of time allowed for spinning.

As discussed above, photoresists of the invention are particularly suitable for use as a top layer in a bilayer photoresist system. As also discussed above, in such a system, a bottom layer of a conventional photoresist, such as novolac polymer based resist, inert polyarylether-sulfone copolymer based resist or a novolac or polyhydroxystyrene-based thermally cross-linkable system. Such bottom layer is typically applied to or coated on a substrate using any of the above described procedures. The bottom layer is then hard baked such as at 230° C. for 2 minutes, after which the present photoimageable compositions are coated on the cured bottom layer. The bottom layers preferably contain an amount of a UV absorbing component, such as an anthracene dye, sufficient for optical density and etch performance. The bottom layers typically have a thickness of from 0.4 to 1 μm. The top layer of the present photoimageable compositions is typically from 0.05 to 1 μm thick, preferably from 0.05 to 0.5 μm, and more preferably from 0.05 to 0.3 μm.

After being coated on the bottom layer, the present photoresist composition top layer is dried by heating (baked) to remove any solvent. It is preferably dried until the coating is tack free. Thereafter, it is imaged through a mask in a conventional manner. The exposure is sufficient to effectively activate the photoactive component of the photoresist to produce a patterned image in the resist coating layer, and more specifically, the exposure energy typically ranges from about 1 to 100 mJ/cm², dependent upon the exposure tool and the components of the photoresist composition.

Photoresists of the invention may be activated by a variety of exposure wavelengths, such as 248, 193, 157 nm and 11-15 nm. However, the photoimageable compositions of the present invention may be used with other radiation sources, such as, but not limited to, visible, e-beam, EUV, ion-beam and x-ray.

Following exposure, the film top layer of the composition is preferably baked at temperatures ranging from about 70° C. to 160° C. Thereafter, the top layer film is developed to form an etch pattern. The exposed resist film is rendered positive working by employing a polar developer, preferably an aqueous based developer, such as quaternary ammonium hydroxide solutions, such as tetra-alkyl ammonium hydroxide, preferably a 0.15 to 0.26 N tetramethylammonium hydroxide; various amine solutions, such as ethylamine, n-propylamine, diethylamine, triethylamine or methyl diethylamine; alcohol amines, such as diethanolamine, triethanolamine; cyclic amines, such as pyrrole, pyridine, and the like. One skilled in the art will appreciate which development procedures should be used for a given system.

The pattern is next transferred to the underlayer or bottom layer by etching, such as with an oxygen reactive ion etch process. After such processing, the resists, both top and bottom layers, may be removed from the processed substrate using any stripping procedures known in the art.

The present photoresist compositions are useful in all applications where photoresists are typically used. For example, the compositions may be applied over silicon wafers or silicon wafers coated with silicon dioxide for the production of microprocessors and other integrated circuit components. As discussed, for many applications, the resist would be used as a bilayer system and disposed over an organic underlayer composition. Aluminum-aluminum oxide, gallium arsenide, ceramic, quartz, copper, glass, spin-on organic dielectrics, spin-on or chemical vapor deposited inorganic dielectrics, and the like are also suitable employed as substrates for the photoresist compositions of the invention. Other chemical vapor deposited layers, such as cap layers, etch stops and the like, may also be used as substrates.

The present photoresist compositions may also be used in optoelectronics applications, such as in the manufacture of optical waveguides, optical interconnects and the like. By “optical waveguide” is meant any device that transmits optical radiation across a two-dimensional substrate surface. Suitable optical waveguides include, but are not limited to, splitters, couplers, spectral filters, polarizers, isolators, wavelength division multiplexing structures, and the like. Such waveguides may also contain active functionality, such as amplification and switching such as with electro-optic, thermo-optic or acousto-optic devices. To be useful as amplifiers, the present waveguides typically contain one or more dopants. Erbium is an exemplary dopant. Such dopants are well known in the art. Thus, the present waveguides suitable for use as amplifiers contain one or more dopants.

The waveguides of the present invention may be manufactured as individual waveguides or as an array of waveguides. Whether such waveguides are prepared as an array depends on the particular use and is within the ability of one skilled in the art. Use of resists of the invention for waveguide applications and manufacture is suitably by procedures disclosed in WO 02/091083 to Gronbeck et al.

In one embodiment, for manufacture of an integrated circuit, a layer of the present compositions is disposed on a wafer substrate (e.g. having a diameter of less than 20 or 10 inches) by spin coating or other application.

The coated substrate is typically then cured, such as by baking, to remove any solvent. Such curing may be a variety of temperatures, depending upon the particular solvent chosen. Suitable temperatures are any that are sufficient to substantially remove any solvent present. Typically, the curing may be at any temperature from room temperature (i.e., 25° C.) to 170° C. Such curing typically occurs over a period of from 5 seconds to 30 minutes. Such curing may be affected by heating the substrate in an oven or on a hot plate.

After curing, the layer of the present composition disposed on the substrate is then imaged by exposure to actinic radiation through appropriate artwork or a mask. Following exposure, the composition is then cured at a temperature of from 40° to 160° C. Curing time may vary but is generally from about 30 seconds to about 1 hour. In a positive-acting resist, the exposed areas are rendered more soluble than the unexposed areas. Thus, the exposed areas may be removed, such as by contact with a suitable solvent, aqueous developer or solvent-water mixture, leaving only the exposed areas remaining on the substrate. Suitable aqueous developers include alkali metal hydroxides such as sodium hydroxide and potassium hydroxide in water as well as tetraalkylammonium hydroxide in water. Such developers are typically used in concentrations from 0.1 to 0.3 N, such as 0.15 to 0.26 N tetramethylammonium hydroxide in water. The choice of developer is well within the ability of those skilled in the art. Such development may be at a variety of temperatures such as from room temperature to about 100° C. The time of such development depends upon the material to be removed and the temperature used, but is generally from about 10 seconds to about 1 hour.

All documents mentioned herein are incorporated herein by reference. The following non-limiting examples are illustrative of the invention.

### EXAMPLES 1-5

### Syntheses of Monomers useful for Preparation of Polymers of the Invention.

### Example 1

### Synthesis of 1,1,1-trifluoro-2-trifluromethyl-pent-4-en-2-ol (BTHB)-triethoxysilane

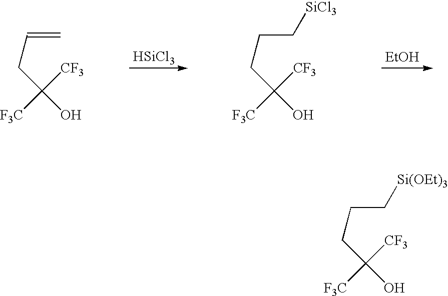 [0126] Part 1. To 10 g of 1,1,1-trifluoro-2-trifluoromethyl-pent-4-en-2-ol (48 mmol) dissolved in 30 ml of anhydrous toluene were added 7.2 g of trichlorosilane (53 mmol) and 5 drops of Karstedt's catalyst solution. The reaction mixture was heated to reflux and while stirred with a magnetic stirring bar was kept at reflux overnight. After this period of reaction the solvent and the other volatiles components present in the product mixture were remover under reduced pressure. ¹H NMR spectroscopy of the residue showed that the formation of the trichlorosilane intermediate had proceeded to completion. The product was then used to form polymers of the invention or the triethoxysilane monomer without further purification.
Part 2. 16 g of 1,1,1-trifluoro-2-trifluromethyl-pent-4-en-2-ol (BTHB)-trichlorosilane (46 mmol) prepared according to the above procedure was added to a 100 ml flask equipped with a magnetic stirrer bar. While the liquid was under a nitrogen atmosphere at ambient temperature and vigorously stirred, 9.6 g of anhydrous ethanol (0.21 mol) was added drop wise to the reaction flask over the course of one hour. After an overnight hold the reaction mixture was stripped of the volatile components under reduced pressure. ¹H NMR spectrum indicated that the reaction had proceeded to completion. The product was then purified by vacuum distillation (70-72° C./6 mmHg).

### Example 2

### Synthesis of hexafluoroisopropylnorbomyl(HFIPNB)-triethoxysilane

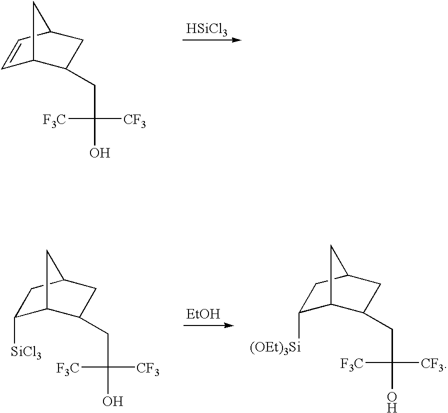

The syntheses of HFIPNB-trichlorosilane and HFIPNB-triethoxysilane are the same as those of BTHB-trichlorosilane and of BTHB-triethoxysilane as set forth in Example 1 above. The tricholorosilane intermediate was used to form polymers of the invention or converted as shown in the equation to the triethoxysilane monomer. The final triethoxysilane monomer was collected at 150° C./6 mmHg.

### Example 3

### Alternative Synthesis of HFIPNB-triethoxysilane

The HFIPNB-triethoxysilane monomer was also synthesized directly by the hydrosilation reaction of HFIPNB with triethoxysilane.

In a 500 mL 3-neck flask were added 70.00 g (255.40 mmol) of BFIPNB, 220 mL of anhydrous toluene, 46.10 g (280.94 mmol) of triethoxysilane, and a catalytic amount of hydrogen hexachloroplatinate(IV) hydrate (H₂PtCl₆xH₂O). The reaction mixture was refluxed for 3 days at 125° C. Excess solvent and residual volatile starting materials were removed by a preliminary distillation, and the hydrosilated product was isolated by a vacuum distillation at 128˜143° C. (0.8˜2.0 mmHg). A colorless viscous liquid was obtained whose purity was determined by proton NMR and gas chromatography (GC).

### Example 4

### Synthesis of BTHB-EOM-triethoxysilane

Part 1: Synthesis of 1,1,1-trifluoro-2-trifluromethyl-pent-4-en-2-ol (BTHB)-ethoxy methyl ether (EOM)

In a 500 mL 3-neck flask equipped with a condenser and a dropping funnel were added 9.69 g (403.79 mmol) of sodium hydride, that is 60% dispersion in mineral oil and washed with anhydrous hexane, and 150 mL of dry THF. Mixture of 70.00 g (336.49 mmol) of BTHB and 50 mL of dry THF was slowly added to the reaction vessel through a dropping funnel. The whole solution was then refluxed for 16 h at 80° C. Added to the reaction mixture were 38.17 g (493.79 mmol) of chloromethyl ethyl ether and 20 mL of THF, and the reaction was stirred overnight under reflux. Reaction was cooled down to room temperature and 200 mL of potassium hydroxide aq. solution was added to dissolve the salt. The aq. phase was extracted with two portions of 200 mL of dichloromethane, and combined organic bottom layer was then dried over magnesium sulfate. The excess solvent and residual starting materials were removed by the use of a rotary evaporator. 67.80 g of a colorless liquid was isolated by a simple distillation at 138˜143° C. (78% yield, purity 99.24% by GC)

Part 2: Synthesis of BTHB-EOM-triethoxysilane

In a 500 mL 3-neck flask were added 60.00 g (225.50 mmol) of BTHB-ethoxy methyl ether, 220 mL of anhydrous toluene, 40.70 g (248.06 mmol) of triethoxysilane, and a catalytic amount of hydrogen hexachloroplatinate(IV) hydrate (H₂PtCl₆×H₂O). The reaction mixture was refluxed for 3 days at 125° C. Excess solvent and residual volatile starting materials were removed by a preliminary distillation, and the hydrosilated product was isolated by a vacuum distillation at 88˜99° C. (0.4˜1.3 mmHg). A colorless viscous liquid was obtained and characterized by NMR and GC.

### Example 5

### Synthesis of 2-trifluormethyl-bicyclo[2.2. 1 ]hept-5-ene-2-carboxylic Acid tert-butyl Ester (TFAMNBB)-triethoxysilane

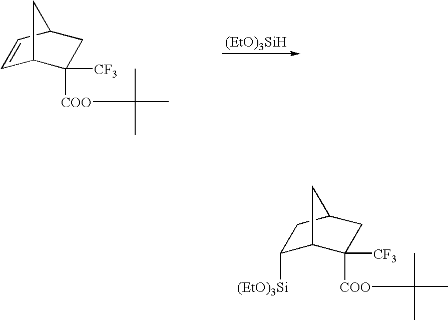

The synthetic procedure is the same as BTHB-EOM-triethoxysilane as set above. A prolonged reaction time is needed to complete the hydrosilation reaction (3-5 days). The product was collected by vacuum distillation at 155-162° C./9 mmHg.

### Example 6

### Syntheses of Polymer of the Invention

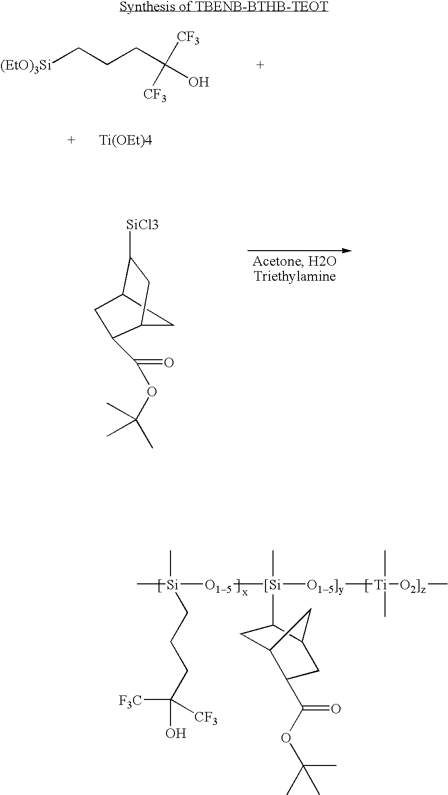 1.687 gms, (5.1 mmoles) of TBuNBSiCl3, 1.83 gms (5.1 mmoles) of BTHB-trisethoxysilane and 2.33 gms (10.2 mmoles) of Ti(OEt)4 were diluted with 15 gms of acetone and stirred at room temperature. To that mixture, over 10 minutes was added a mixture of 2.58 gms of triethylamine and 2.5 gms of water. The mixture was stirred at room temperature for 2 hours. The pH was adjusted from 7.85 to 9.0 with the addition of 1.7 gins of triethylamine and the system was brought to reflux (57C) and held at reflux for 44 hours. The mixture was then cooled to room temperature and quenched in 200 ml of deionized water. The solids were than isolated by filtration and washed with 2×25 ml deionized, followed by 2×25 ml heptanes. The solids were than vacuum dried at 50C to yield 3.2 gms of product. Mw 11933, Mn 2488, PD 4.8.

### Example 7

### Photoresist Preparation and Lithographic Processing

A photoresist composition is prepared by admixing the following components in the following amounts:

| Component | Amount |
|---|---|
| Ti/Si-polymer as prepared in Example 6 | 7.58 wt. % of formulation |
| Photoacid generator | 5.2 wt. % of polymer |
| Basic additive | 0.24 wt. % of polymer |
| Surfactant | 0.1 wt. % of polymer |
| Solvent | to provide 92 wt. % fluid |
| | formulation |

In that formulation, the photoacid generator is triphenyl sulfonium perfluorobutanesulfonate; the basic additive is tetrabutylammonium lactate; the surfactant is R-08 (commercial name MEGAFAC R-08, a fluoroacrylate ester copolymer); and the solvent is 2-heptanone.

The formulated resist is spin-coated onto a silicon wafer over an organic polymer layer. The underlying organic layer is previously crosslinked by curing at 215° C. for 90 seconds. The applied resist coating layer is soft-baked at 125° C. for 60 seconds and then exposed through a photomask with 193 nm radiation. The imaged resist layer is post-exposure baked at 105° C. for 60 seconds and then developed by treatment with 0.26N aqueous alkaline developer for 60 seconds.

The invention has been described in detail with reference to particular embodiments thereof. However, it will be appreciated that those skilled in the art, upon consideration of this disclosure, may make modifications and improvements within the spirit and scope of the invention.

1. A photoresist composition comprising a photoactive component and a polymer component,
the polymer component comprising a polymer that comprises Ti and Si atoms.

2. The photoresist composition of claim 1 wherein the polymer is an organic polymer.

3. The photoresist composition of claim 1 wherein the polymer is obtainable by reaction of one or more compounds of the formula
M(Y)₄
wherein each M is Si or Ti;
each Y is the same or different and at least two Y groups are reactive groups.

4. The photoresist composition of claim 1 wherein polymer comprises a moiety chosen from among a photoacid-labile ester, a photoacid-labile acetal or a fluorinated alcohol.

5. The photoresist composition of claim 1 wherein the polymer comprise a structure of the following formula: 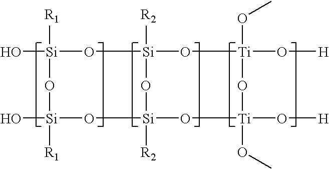
wherein each R₁ and each R₂ independently may be hydrogen; optionally substituted alkyl; optionally substituted carbon alicyclic; optionally substituted aryl
x, y and z are each mole percents of the respective polymer units based on total polymer units are each greater than zero.

6. A coated substrate comprising:
a) an underlying organic polymer composition coating layer applied over a substrate surface;
b) a coating layer of a photoresist composition of claim 1 disposed over the underlying polymer composition coating layer.

7. A method for forming an electronic device, comprising:
(a) applying a photoresist composition of claim 1 on a substrate;
(b) exposing the photoresist composition coating layer to activating radiation and developing the exposed photoimageable layer.

8. An article of manufacture comprising a substrate comprising a coating layer of a photoresist composition of claim 1.

9. An organic polymer that comprises Ti and Si atoms.

10. The polymer of claim 9 wherein the polymer is photoimageable.
